(19) United States
(12) Patent Application Publication
(10) Pub. No.: US 2015/0213384 A1
(43) Pub. Date: Jul. 30, 2015

(54) System And Method For Capital Budgeting

(71) Applicants: Raymond Dufresne, Salem, NH (US); Frank Paul Salamone III, Sudbury, MA (US); Thomas Frederick Bart, Raymond, NH (US)

(72) Inventors: Raymond Dufresne, Salem, NH (US); Frank Paul Salamone III, Sudbury, MA (US); Thomas Frederick Bart, Raymond, NH (US)

(21) Appl. No.: 14/685,261

(22) Filed: Apr. 13, 2015

Related U.S. Application Data
(63) Continuation of application No. 12/329,268, filed on Dec. 5, 2008.
(60) Provisional application No. 61/012,272, filed on Dec. 7, 2007.

(51) Int. Cl. G06Q 10/06; G06Q 50/16

(52) U.S. Cl. CPC G06Q 10/06313; G06Q 50/16

(57) ABSTRACT

A system for generating a capital budgeting plan taking into consideration specific real property information and an objective List of Rules selected by a user(s) against which all projects are compared. The system generates a Ranked List of requirements based on the real property information and the List of Rules. The Ranked List is based on the objective criteria selected by the user to provide a transparent and defensible capital budget plan.

### FIELD OF THE INVENTION

The invention relates to a system for listing and scheduling various projects and more specifically, to a system and method for ranking and budget allocation for construction/maintenance projects for a property(s) based upon a set of rules and a data set of information relating to the property(s).

### BACKGROUND OF THE INVENTION

Organizations and companies that occupy and/or possess numerous real properties, often find it a challenge to organize, maintain, improve and modify those properties. Often, there are various competing interests and the funds available will not allow all the potential projects to be completed simultaneously or within, for example, a fiscal year. For instance, an organization (such as a school) may want to upgrade certain classrooms with new audio-visual equipment, however, the roof on the building may require immediate repair where failure to do so could result in collateral damage to the building. The organization must then determine which project(s) to complete, the priority that each project should have relative to the other identified projects, and how to allocate the available funds to complete these projects.

Most organizations develop their capital budgets by collecting data from each department (relating to, for example, various properties) and then try to rationalize the needs against the available funds. This is typically accomplished by considering each project to determine priority, cost and schedule. However, as each department has different priorities, this can lead to conflicts and delays in finalizing the budget. Additionally, this process can be very time-consuming when a relatively large number of properties are involved and perhaps many hundreds of projects need to be considered.

Another problem with current methods is that if a project is identified subsequent to the project consideration process described above, the newly identified project must be reviewed in light of all the projects on the list (or at least a large portion of the projects listed) to determine where the newly identified project ranks relative to the ones already on the list. This can be quite time-consuming and burdensome, especially after the original review process.

Still another problem with the current project consideration method is that, often, this method only concerns or addresses projects for the current year and not needs that may span years or could be important in the future.

Additional problems arise with current methods because the processes, and therefore the criteria for making the decisions, are not entirely transparent to review and oversight. This can make the process of receiving authorization to proceed with projects more difficult to obtain. If the decision-making process were more transparent, the budget presented for review and authorization would be more easily defensible. This would have the effect of streamlining the review and decision-making process.

### SUMMARY OF THE INVENTION

What is desired therefore is a system and method that generates a capital budget plan allowing for various projects to be identified, quantified and ranked relative to each other based on objective criteria.

It is further desired to provide a system and method that generates a capital budget plan, such that, after a list of various projects have been quantified and ranked relative to each other based on objective criteria, provides for adjustment to that list (based on the same objective criteria) when an additional project(s) is added to the list.

It is still further desired to provide a system and method that generates a capital budget plan for the identification, quantification and ranking of various potential projects based on objective criteria for the current fiscal year and for future fiscal years.

It is still further desired to provide a system and method that generates a capital budget plan allowing for various projects to be identified, quantified and ranked relative to each other based on objective criteria where the objective criteria allows for transparent review and oversight of the generated capital budget plan.

These and other objectives are achieved in one advantageous embodiment of the invention, by the provision of a Capital Budget Ranking Module (CBRM) that allows an organization to develop one or more sets of priorities to be applied to all the capital needs the organization may have. By using an objective model that looks across the entire organization, a more transparent and defensible budget can be created.

All the capital needs of the organization are rank-ordered as defined by the developed priorities to identify the most important capital needs. The mathematical approach, using pair-wide analysis, may be augmented by individuals within the organization to create an optimal budget.

Multiple budgets may be defined, as many organizations have more than one source of funding and different classes of capital assets that may need their own prioritization strategy. The multiple budget scenarios may further be compared to see the impact on the future condition of the portfolio due to different investment levels and help the organization define the appropriate level of funding. Based on the agreed-upon assigned priorities, a multi-year capital budget for capital funding may be produced that will achieve the organization's facility and business objectives.

The CBRM provides the user with ability to apply decision criteria to a set of assets, ultimately generating a multiyear budget. CBRM allows users to prioritize requirements based on the more traditional parameters including Facility Condition Index (FCI) and Action Year, and on any other asset or requirement parameter. Users can create multiple budget scenarios on the same asset portfolio, apply varying levels of funding based on straight annual funding, funding incremented by inflation or other factors, or funding as a percentage of replacement value.

By varying the prioritization of requirements based on a flexible decision process (for example prioritizing environmental or regulatory compliance requirements highest) a user can create multiyear budgets that are fine-tuned to the organizations changing condition or strategic goals. In each funding scenario, the overall effect of the budgetary expenditures on the asset FCI can be quickly determined.

Once the final budget scenario has been determined, each requirement in the budget may be identified and marked as part of the budget. The budgeting system includes some key features including: the ability to apply pair-wise decision processes to prioritize requirement and asset (building) parameters; provision of multiple funding options that are supported including specific annual funding, extrapolation funding (increase by a specific percentage each year), or funding as a percentage of replacement value of the portfolio; quick and efficient creation of projects based on requirements chosen in each budget, for all years; export of decision criteria, budget results, ranked requirements, and all data to, for example, Excel format, CSV, and PDF; and generation of reports allowing users to capture all ranked requirements sorted by region, campus, asset, or by other parameters important to the organization.

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “network” as used herein includes both networks and internetworks of all kinds, including the Internet, and is not limited to any particular network or inter-network.

The terms “first” and “second” are used to distinguish one element, set, data, object or thing from another, and are not used to designate relative position or arrangement in time.

The terms “coupled”, “coupled to”, and “coupled with” as used herein each mean a relationship between or among two or more devices, apparatus, files, programs, media, components, networks, systems, subsystems, and/or means, constituting any one or more of (a) a connection, whether direct or through one or more other devices, apparatus, files, programs, media, components, networks, systems, subsystems, or means, (b) a communications relationship, whether direct or through one or more other devices, apparatus, files, programs, media, components, networks, systems, subsystems, or means, and/or (c) a functional relationship in which the operation of any one or more devices, apparatus, files, programs, media, components, networks, systems, subsystems, or means depends, in whole or in part, on the operation of any one or more others thereof.

It should be noted that the term “facility” and “facilities” as used herein are intended to include real estate and any improvements made thereon including, for example but not limited to, building(s), infrastructure associated with the building(s) whether inside or outside of the buildings, roads, pathways, outdoors recreational areas and systems associated therewith.

The terms “Facility Condition Index” or “(FCI)” as used herein is a grading system used to rate the condition of a facility with a rating of 0.0 equating to a facility in perfect condition and ranging to a rating of 1.0 where the cost to repair equals the cost to replace the facility.

In one advantageous embodiment a method for generating a capital budgeting plan is provided comprising the steps of storing real property information on a computer having a storage, the real property information including data relating to the current status and configuration of the real property and forming a set of rules providing a relative ranking of project criteria for the real property, the project criteria selected from the group consisting of: FCI, project category, project system and combinations thereof. The method further comprises the steps of inputting project information into the computer relating to real property projects for the real property and ranking the real property projects based on the real property information and the set of rules. The method further includes the steps of generating a list of real property projects based on the ranking and displaying the ranked list to a user.

In another advantageous embodiment a system for generating a capital budgeting plan for real property is provided comprising a computer having software executing thereon for generating a capital budgeting plan and a storage accessible by the computer. The system further includes real property information stored on the storage, the real property information including data relating to the current status and configuration of the real property. The system still further includes a set of rules stored on the storage, the set of rules providing a relative ranking of project criteria for the real property, the project criteria selected from the group consisting of: property type, FCI, project category and combinations thereof. The system also includes project information entered into the software program, the project information relating to real property projects for the real property. The system is provided such that the software ranking the real property projects is based on the real property information and the set of rules. The system further comprises a list of real property projects generated by the software, where the list is based on the ranking and a display for displaying the ranked list to a user.

Other objects of the invention and its particular features and advantages will become more apparent from consideration of the following drawings and accompanying detailed description.

### BRIEF DESCRIPTION OF THE DRAWINGS

FIG. 1 is a screen shot of Ranking Strategies definitions.

FIG. 2 is a screen shot of the Overall Ranking according to FIG. 1.

FIG. 3 is a screen shot defining Category and illustrating a relative ranking of Energy versus the various Category listings and Environmental versus the various Category listings according to FIG. 1.

FIG. 4 is a screen shot of the Overview illustrating the relative rankings of the various selected definitions according to FIG. 1.

FIG. 5 is a screen shot of Budget Scenarios based on the selected Ranking Strategies according to FIG. 1.

FIG. 6 is a screen shot illustrating graphical results for the Budget and Impact on FCI according to FIG. 5.

FIG. 7 is a screen shot of the Ranked List of Requirements according to FIG. 1.

FIG. 8 is a report ranking the List of Requirements according to FIG. 7.

FIG. 9 is a report illustrating the graphical results for the Budget and Impact on FCI according to FIG. 6.

FIG. 10 is a screen shot illustrating Requirements costs extending over a multi-year budget scenario.

FIG. 11 is a screen shot of the Tag Requirements for Project Creation.

FIGS. 12-14 variously illustrate screen shots for Tag Requirements including specific asset and requirements information and an adjusted Ranked List showing Overrides.

FIG. 15 is block diagram according to FIG. 1.

### DETAILED DESCRIPTION OF THE INVENTION

Referring now to the drawings, wherein like reference numerals designate corresponding structure throughout the views.

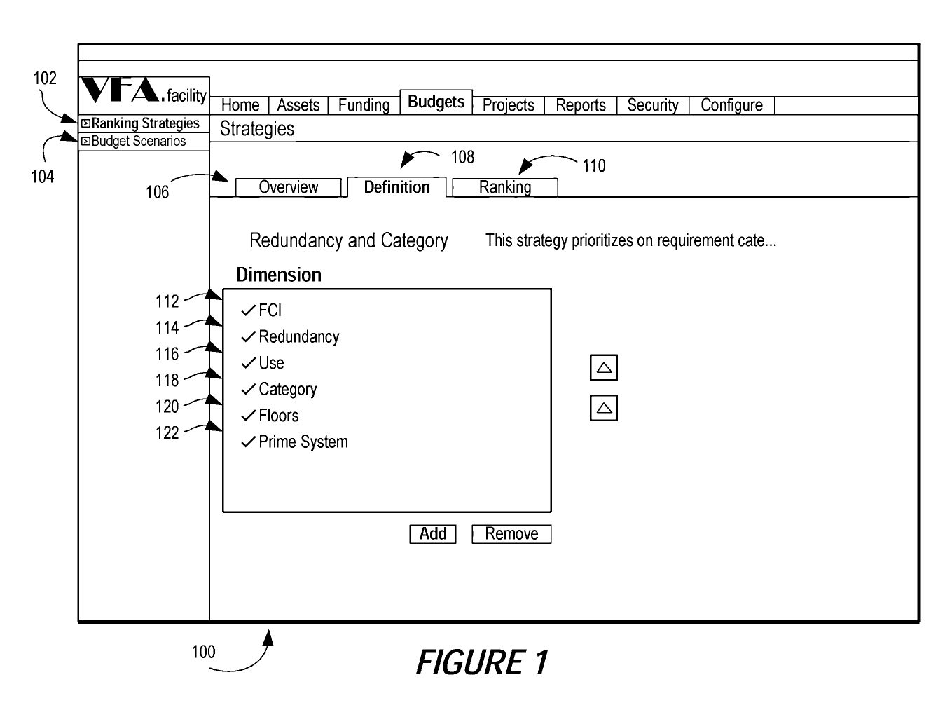

FIG. 1 is a screen shot illustrating system 100, which in this embodiment includes two tabs: Ranking Strategies 102 and Budget Scenarios 104. In FIG. 1, the Rankings Strategies tab is shown highlighted, which brings up a list of tabs including, for example, Overview 106, Definition 108 and Ranking 110.

A list of various project criteria, which in this example, includes FCI 112, Redundancy 114, Use 116, Category 118, Floors 120 and Prime System 122. It should be noted that the present project criteria illustrated is provided only as an example and may include additional project criteria or fewer based on the requirements of the various real property and the organization preparing the budget plan.

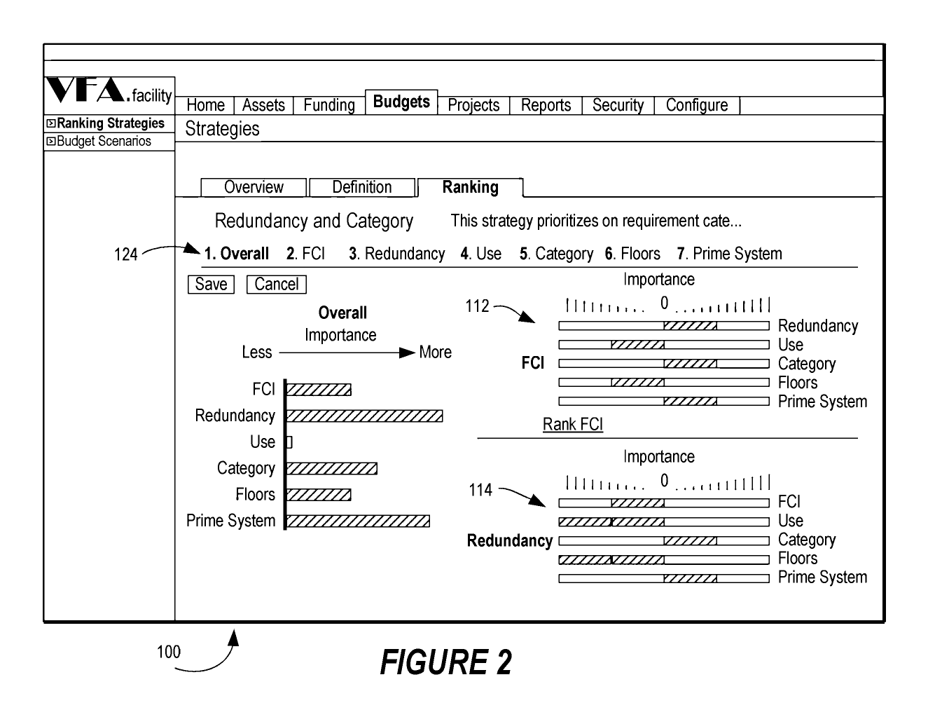

FIG. 2 is another screen shot illustrating the Overall ranking 124 of the various project criteria shown in FIG. 1. In this example, a user has the option to provide relative rankings of the various project criteria relative to each other for the generation of a set of rules against which the system will make decisions. For example, FCI 112 is a project criteria that was initially selected. The user has the option to rank the relative importance of FCI 112 versus all the other project criteria, which in this case includes Redundancy 114, Use 116, Category 118, Floors 120 and Prime System 122.

Additionally, the user has the option to provide relative rankings of each of the selected project criteria relative to each other, which is illustrated in FIG. 2 where a further one-to-one ranking of Redundancy 114 is ranked against each of the other project criteria. While only FCI 112 and Redundancy 114 are illustrated in FIG. 2, it is understood that each of the project criteria may be ranked directly against each of the other project criteria such that all criteria are directly ranked against each other. This direct ranking is used by the system in generating a Set of Rules used to generate a Ranked List of requirements.

It can be seen in FIG. 2 from the Overall ranking of the various project criteria, that Redundancy 114 is ranked higher than all of the other project criteria, while Prime System 122 is the next highest ranked and so on.

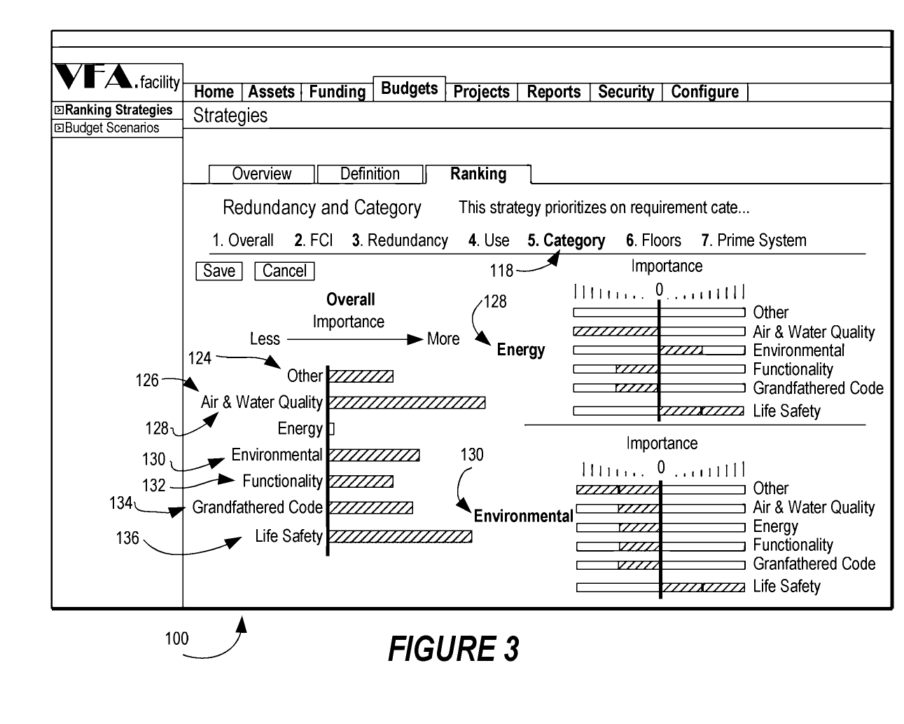

Referring now to FIG. 3, an illustration of one of the project criteria (e.g. Category 118) is shown. In this example, Category 118 comprises the following possible values: Other 124, Air and Water Quality 126, Energy 128, Environmental 130, Functionality 132, Grandfathered Code 134 and Life Safety 136. Accordingly, a user has the option to quantify the importance of each the various criteria in Category 118. As can be seen from FIG. 3, the user has the option to rank each criteria versus each of the other criteria in Category 118. For example, Energy 128 is ranked directly against each of the other criteria in Category 118 and Environmental is ranked directly against each of the other criteria. While Energy 128 and Environmental 130 are illustrated, it should be noted that each criteria may be directly ranked against other criteria in Category 118.

This allows the user to create rules on a global level so that the user can specify which criteria is more important to the user (or organization) relative to the other categories. For example, in the screen shot illustrated, the user has selected Life Safety 136 as the most important criteria to be maintained (replaced/improved/etc.), followed by Environmental 130 and Energy 128. This allows the user complete control in creating a Set of Rules that reflects the specific ideals or mission plan of the organization.

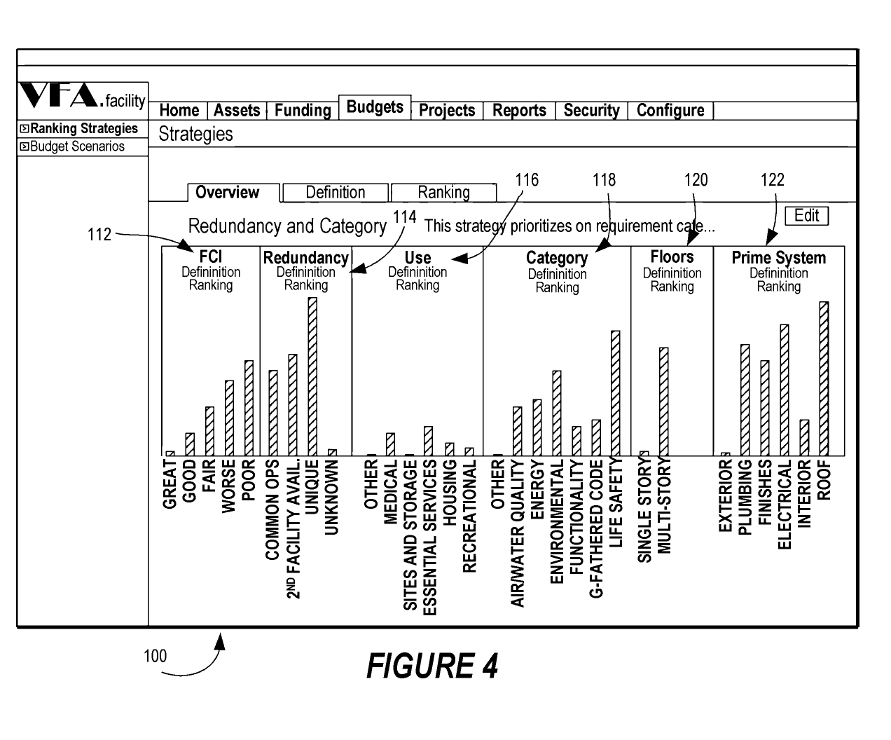

Referring now to FIG. 4, an Overview of all the various project criteria is illustrated. For clarity, a description of each of the various project criteria will be provided, however, it should be noted that virtually any type of project criteria may be used and the particular criteria shown is for illustration purposes only and should not limit the scope of the invention.

FCI 112 is provided with five possible values including: Great, Good, Fair, Worse and Poor. FCI is a number that is assigned to a building that provides an overall estimated rank for the current condition of the building. Therefore, while FCI 112 is divided into five possible values, it is contemplated that any number of values may be used, or simply the FCI number itself could be used. In this example, the lower the FCI ranking (e.g. the poorer condition the building is in) the higher in importance each project associated with that building is assigned. For example, if a Life Safety system in two different buildings is in need of repair/replacement, the Life Safety system in the building with the lower FCI will be ranked higher on the Ranked List that is eventually generated by the system 100.

The next project criteria listed is Redundancy 114, which is provided with four possible values including: Common Operations, Secondary Facility Available, Unique and Other. In this way, the user can rank the relative importance of projects in various facilities based on whether the facility is relatively common facility or a unique facility for the organization. For example, it could be that a city has a number of projects to complete over the course of a fiscal year. One of the projects is in one of the city's eight fire stations and the other is in the city's only waste water treatment plant. If the operations at one of the city's fire stations were interrupted, it is understood that seven other facilities are on-line so-to-speak to handle the temporarily interrupted operations of the eighth facility. However, if the operations of the unique facility were interrupted, there is absolutely no other facility available to perform the function. Accordingly, real properties that are designated “unique” are given the highest priority so the interruption in services are avoided.

The next project criteria listed is Use 116, which is provided with six possible values including: Other, Medical, Sites and Storage, Essential Services, Housing and Recreational. This allows the user to provide a relative ranking to the importance of the use a particular real property is put to. As can be seen in this particular example, the use a particular real property is put to is ranked relatively lower in importance than, for example, the redundancy classification of the real property. Again, while six criteria are listed under Use 116, it is contemplated that virtually any number of criteria may be specified.

The next project criteria listed is Category 118, which is provided with possible values previously described in connection with FIG. 3.

The next project criteria listed is Floors 120, which is provided with two possible values including: Single Story and Multi-Story. Again, as stated above, virtually any number of criteria may be included such that the Set of Rules generated by system 100 will reflect the goals and mission of the organization.

Finally, the last project criteria listed is Prime System 122, which is provided with possible values including: Exterior, Plumbing, Finishes, Electrical, Interior and Roof. This again allows the user to provide a relative ranking for the importance of various criteria listed in Prime System 122. For example, it can be seen that Roof projects are provided with greater importance than, for example, Finishes. In this particular example, the user may be concerned about collateral damage to the building if the roof leaks and therefore has provided a higher importance to such projects. However, any number of criteria may by listed or provided under this listing, such as, for example but not limited to, HVAC, communications systems including voice and data, etc.

The pair wise ranking of each criteria against other criteria allows for the relative ranking of various criteria versus every other criteria. The selected criteria and the relative importance of each criteria comprises the Set of Rules generated by the user and used by the system to allocate values to various projects.

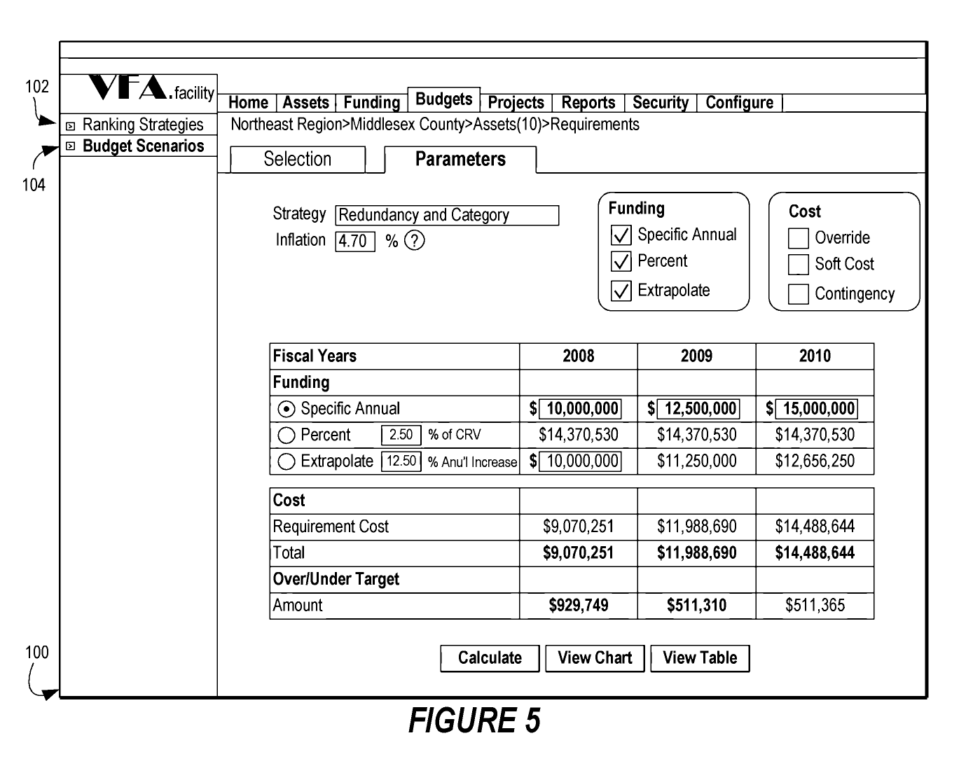

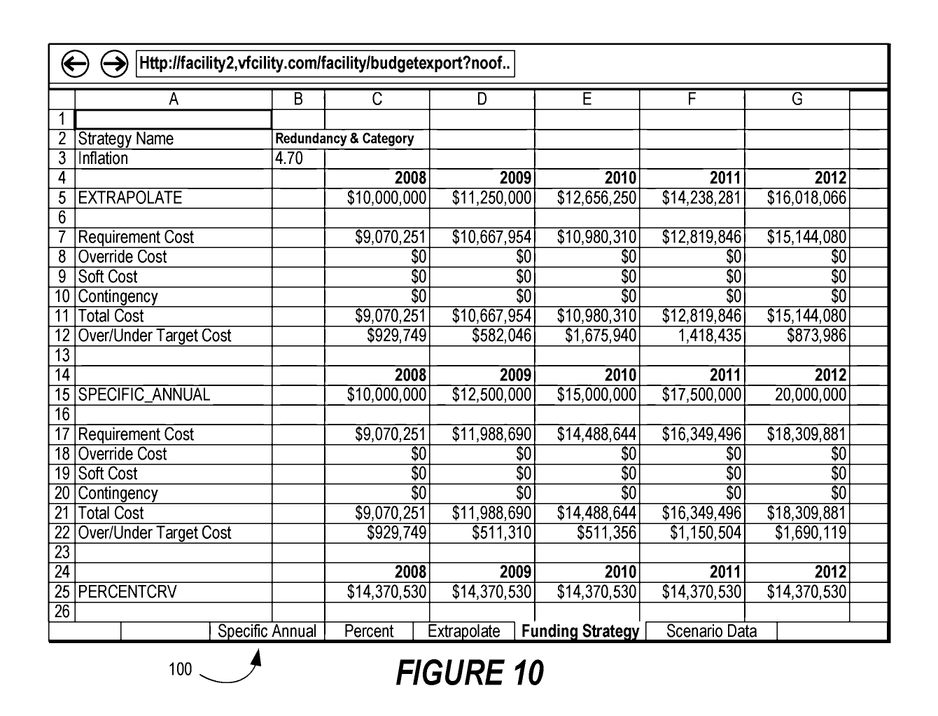

As can be seen in FIGS. 5 and 10, the Budget Scenarios 104 tab has been selected now that the Ranking Strategies 102 has been determined. Here the user is provided wide latitude for allocating a budget for a project. For example, a user may allocate a specific amount of funding per year for a project, or may provide a percent of the total project cost per year, or extrapolate a percent annual increase. This allows the user to see various funding scenarios so as to be able to get an accurate picture of project costs and to allocate and schedule appropriate funds.

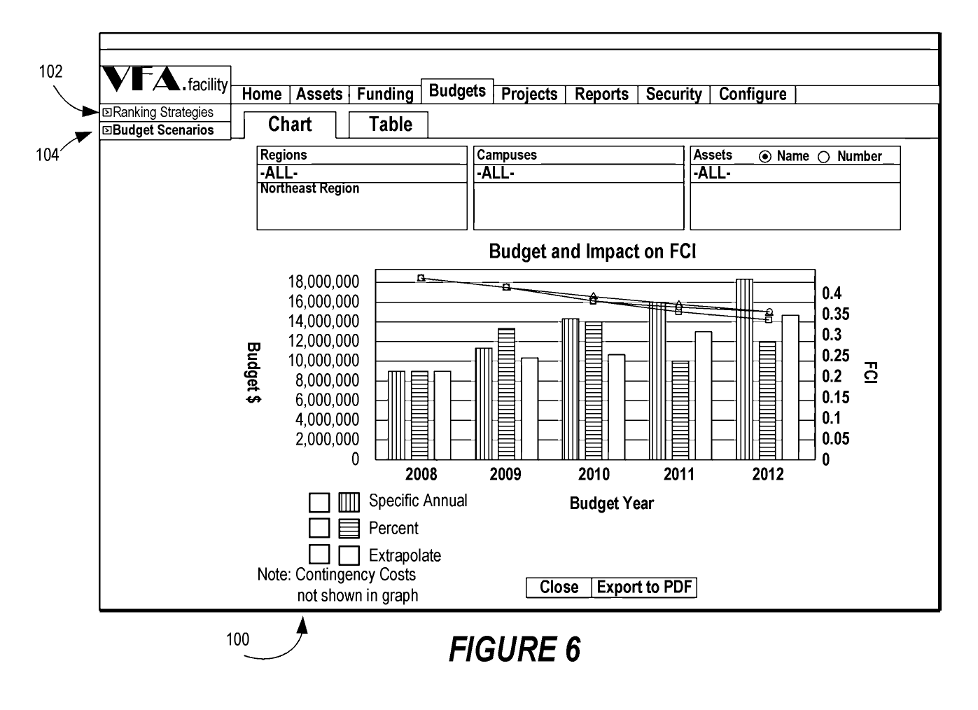

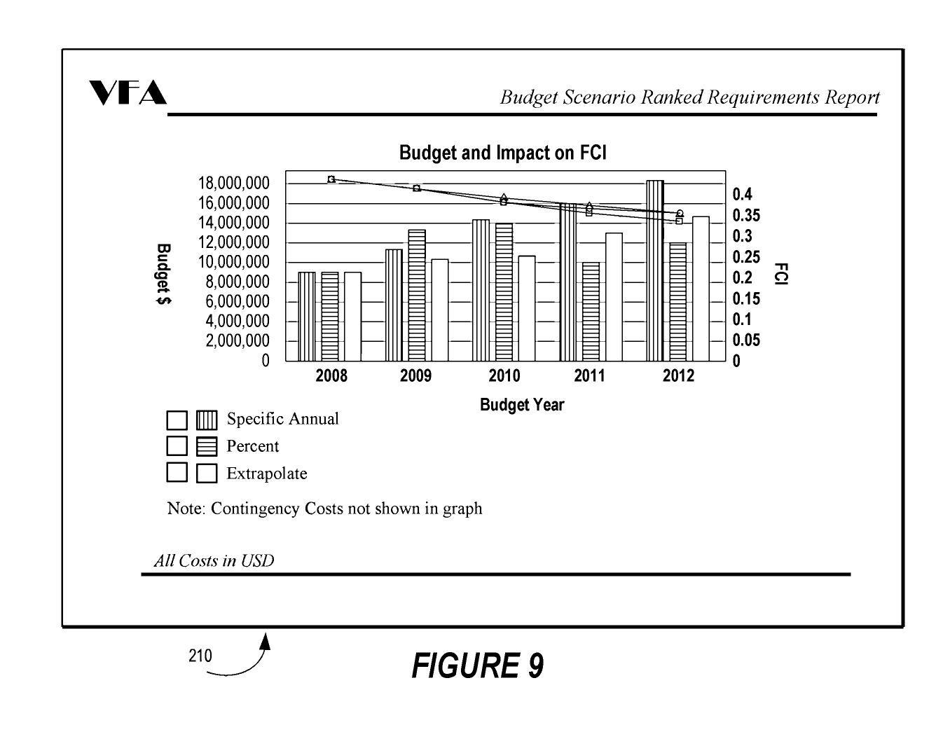

FIG. 6 is a screen shot illustrating the allocated funding for a particular real property and the effect of the particular fund allocation to the building FCI. This can be shown on a year to year basis with the particular funding for each building listed and the FCI for each building shown over the course of a number of years. This is provided as graphical information for the user, which allows the user to immediately see how funding decisions will affect each building over time. FIG. 9 illustrates a report 210 that may be generated by system 100 depicting the information provided, for example, in FIG. 6.

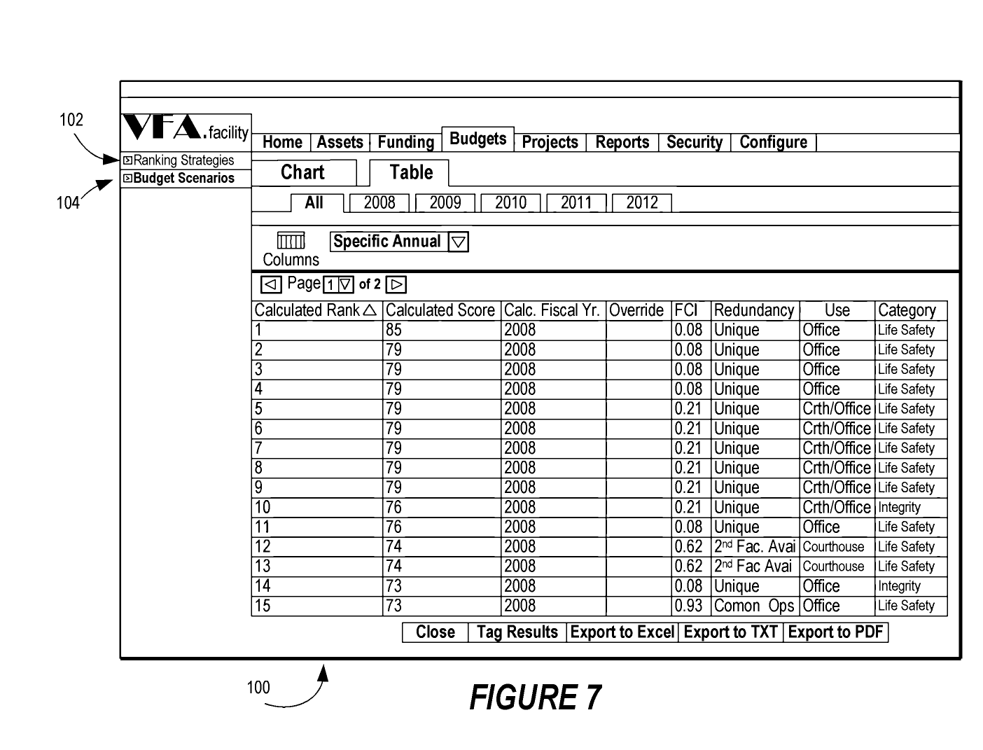

Referring to FIG. 7 a screen shot of a Ranked List of requirements is illustrated. For example, various requirements (projects) are listed in a ranked order extending from one to number fifteen illustrated in the particular screen shot. The highest ranked requirement received a calculated score of eighty-five (85). The various criteria are listed including, for example, the FCI listed as “0.08”, the redundancy listed as “unique”, the use listed as “office” and the category listed as “life safety.”

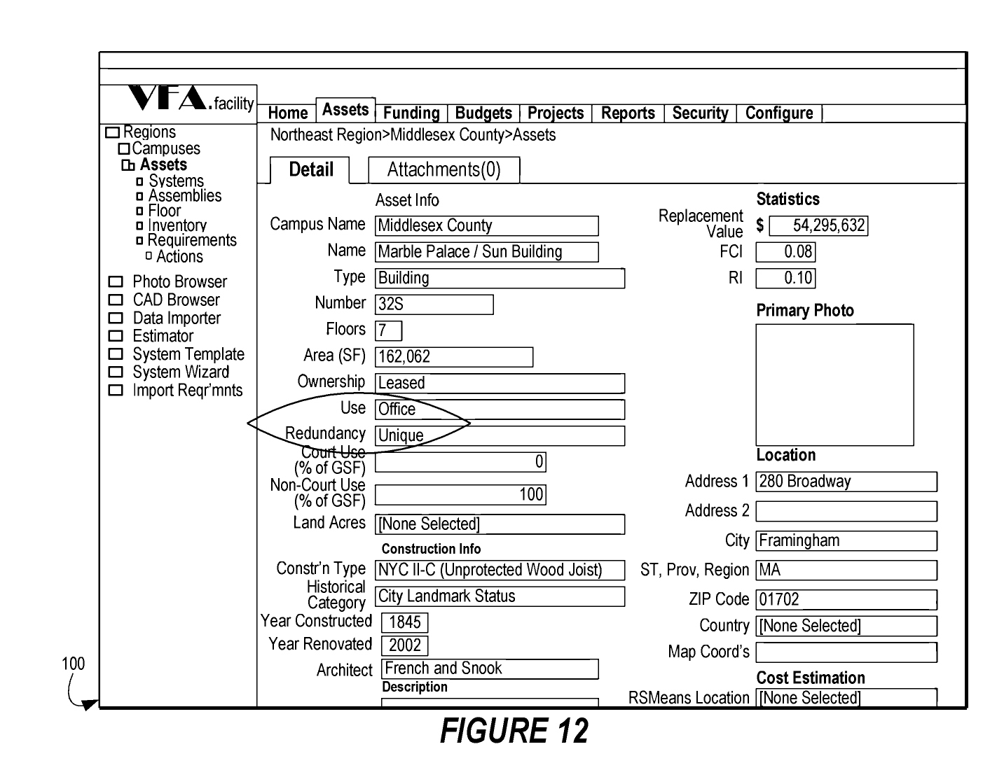

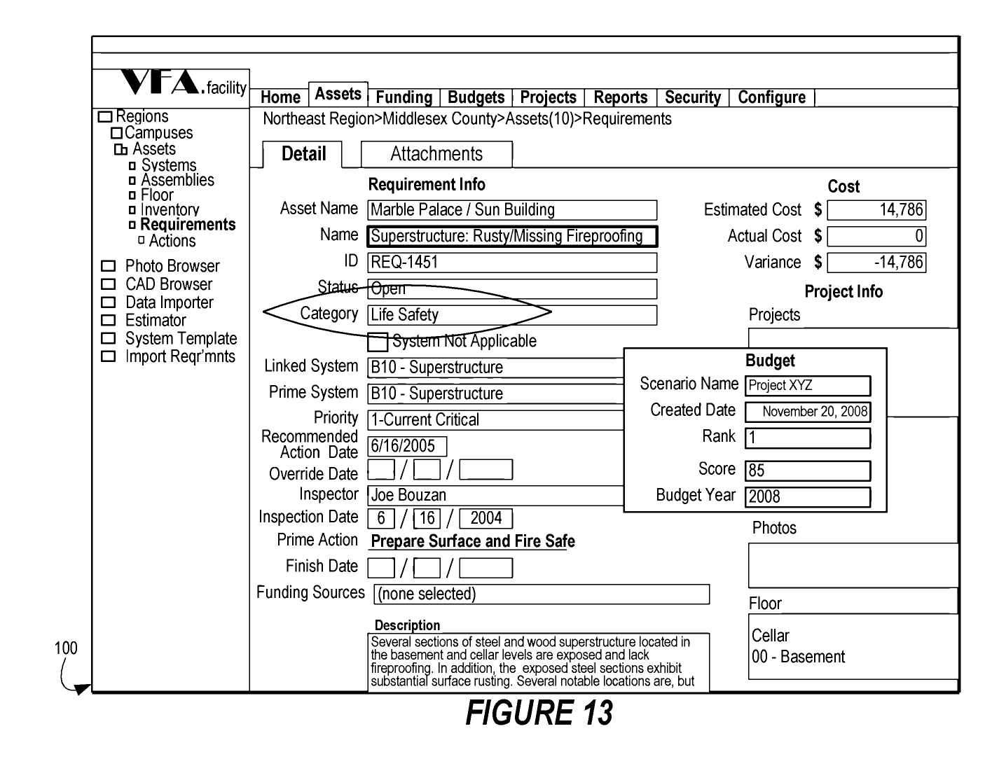

Accordingly, to generate the Ranked List of requirements, the system 100 will receive real property information data relating to the current status and configuration of the real property. This is shown, for example, in FIGS. 12 and 13 including the type of real property, the location, the classification of the real property and so on. The real property information may be quite detailed and include the exact specification for the building and the building systems with information relating to the current status of those systems. For example, this information is used to determine what projects need to be ranked.

Once the real property information has been input into the system 100, the user then determines the Set of Rules the system 100 will apply to the various requirements or projects that are identified. The process of determining the Set of Rules has been described in connection with FIGS. 2-6 relating to the setting of Ranking Strategies.

Once the real property information is supplied to system 100 and the Set of Rules is set by the user, the system 100 may then generate the Ranked List of requirements as illustrated in FIG. 7. The Ranked List may further list the criteria that were used in generating the calculated score.

It should be noted that, while various functions and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein.

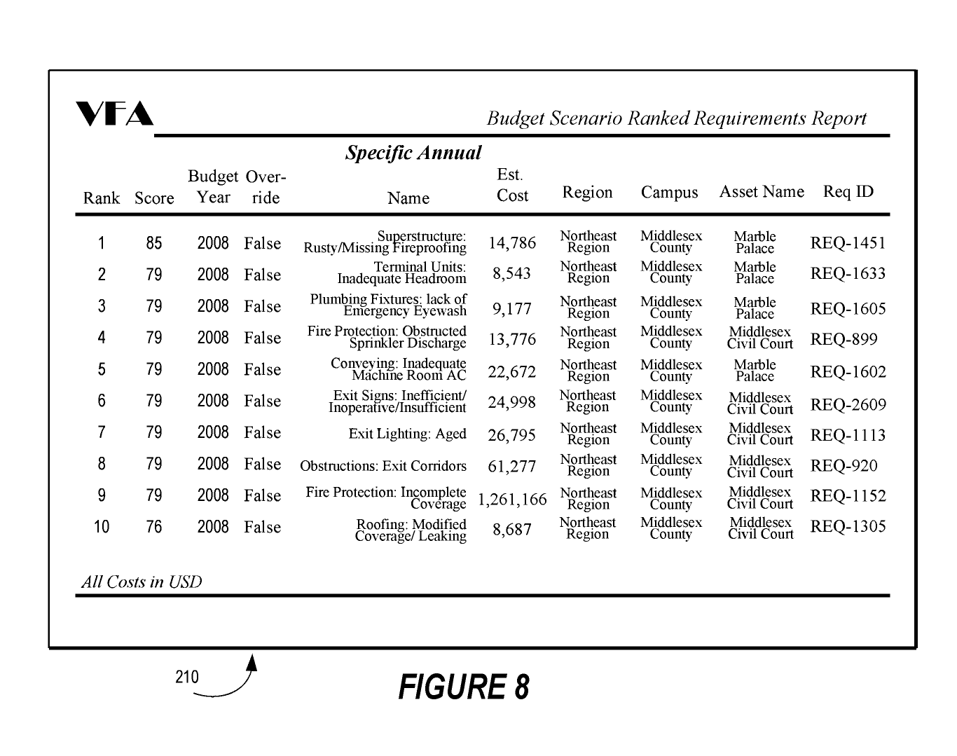

Referring now to FIG. 8, a Budget Scenario Ranked Requirements Report is provided that includes a ranking for each requirement (or project) and further includes a listing of the budget year, a name of the project (may include a descriptive name), an estimated cost for the project, and various other information useful to the user. Also listed on the Budget Scenario Ranked Requirements Report is a listing of whether an Override is present for the project.

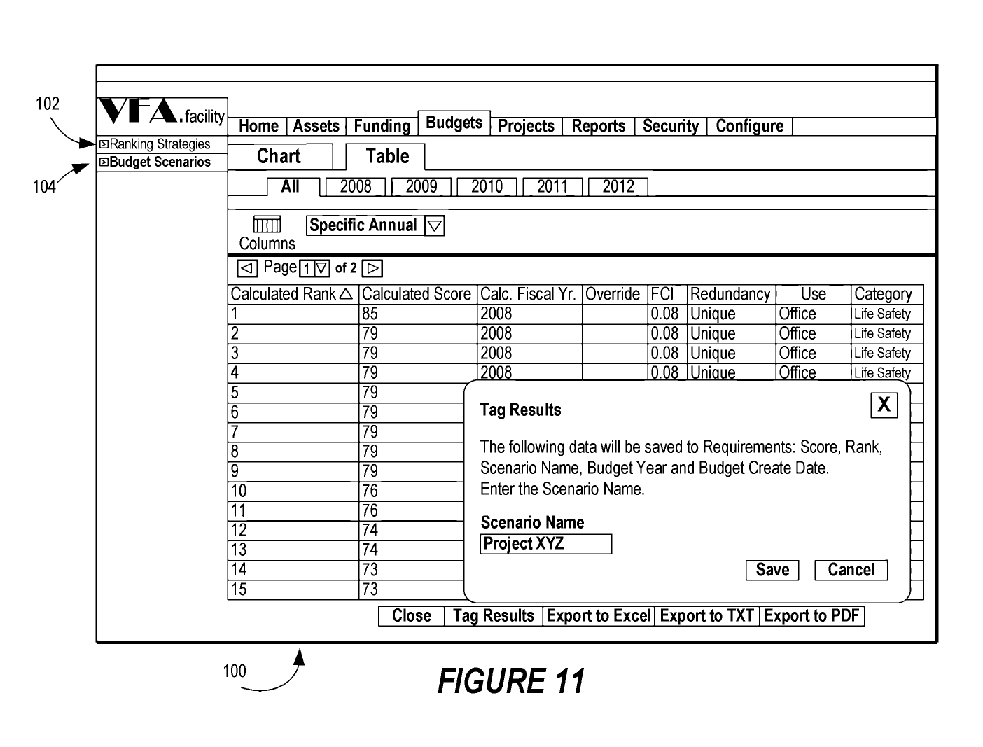

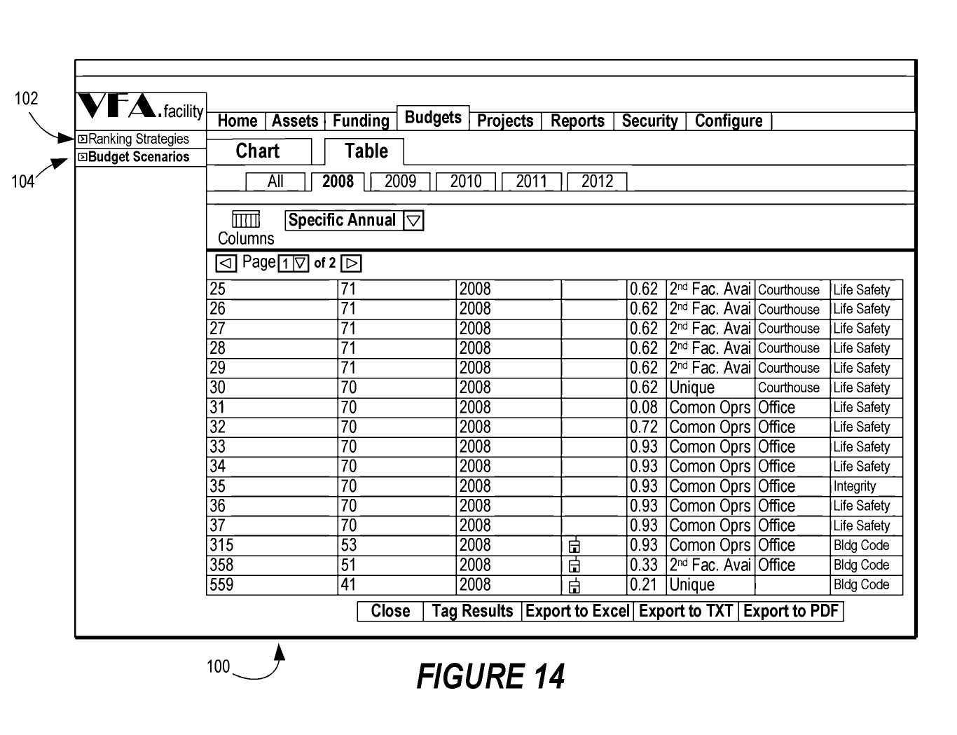

Referring to FIG. 11, it can be seen that the user is allowed to tag various requirements (projects) with information and/or data. This may allow the project to be ranked out of order such as is depicted in FIG. 14. This allows the system to apply the Set of Rules to the real property information to generate the Ranked List, but also allows the user to specify particular requirement (projects) to be completed earlier (e.g. within a fiscal year) rather than having to wait a number of years based on the calculated score. As can be seen in FIG. 14, at the bottom of the list the calculated rank of the projects ends at thirty-seven (37) and then jumps to three hundred fifteen (315). The system 100 will determine how many of the requirements on the Ranked List can be completed in the fiscal year depending upon the available funds. In this case, the system included a number of lower ranked projects in the fiscal year funding as these projects were tagged meaning an override was placed on the ranking thereby forcing these projects into the current year queue to be completed ahead of higher ranked projects allowing complete control over the process.

It can be seen from the above-described system that an objective, transparent and defensible Ranked List of requirements can be created for review and approval. The Ranked List will be generated on objective criteria that correspond to the organizations objectives and mission. Rather that providing a list including subjective analysis, the Ranked List generated by the system provides a global Set of Rules that is applied across the board to all projects. This allows for review of the ranked projects in a fair and objective manner, which provides a higher comfort level to those performing the review and a more efficient review process.

Additionally, unlike known systems, the Ranked List can quickly and easily be adjusted and a new report generated when additional requirements (projects) are identified. All that is necessary is to provide the real property information and the system will apply the Set of Rules to the new information generating a new Ranked List of requirements. Compared to known systems, this saves a tremendous amount of time and energy, while quickly providing a new Ranked List for review and approval. The result is a highly repeatable system that applies objective rules to all projects providing reviewers a high level of confidence in the relative ranking of various projects. The system further allows for multi-year budgets to be generated and funding to be allocated as desired. The final Ranked List of requirements can be used, once approved, to generate work orders, thereby saving additional time and money.

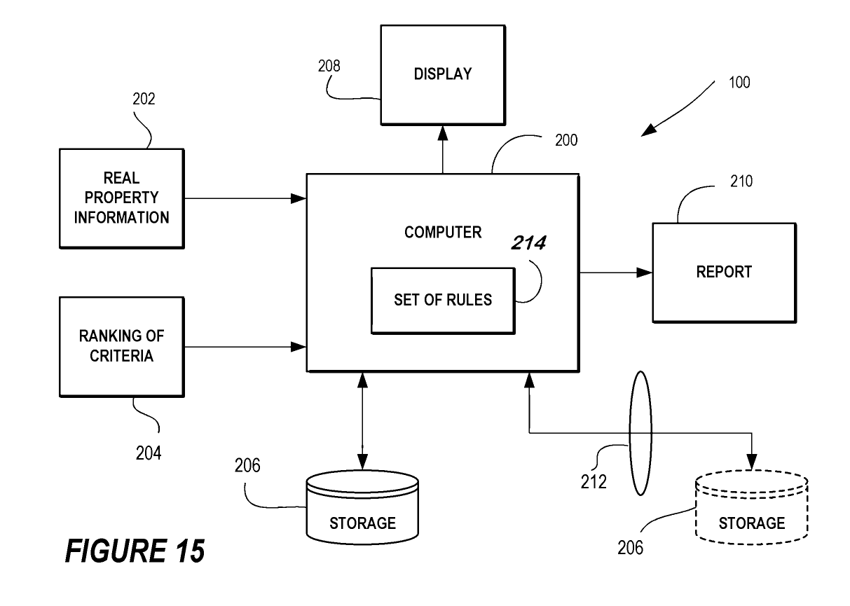

FIG. 15 is a block diagram depicting system 100, which in this embodiment includes computer 200, real property information 202, a Set of Rules 204, a storage 206, a display 208 and a report 210.

The real property information 202 may include any of the information as previously described relating to a particular real property. The ranking of criteria and of the possible values within each criterion 204 is performed by the user as previously described to generate a Set of Rules 214. Both the real property information 202 and the Set of Rules 214 may be stored in storage 206, which is accessible by computer 202. Storage 206 may be a local storage device or alternatively a remote storage device (shown in dashed line) that is accessible via, for example, a network connection 212 such as the Internet.

The display 208 may comprise virtually any type of display for inputting and displaying various information to the user. Additionally, the report 210 may comprise any of the reports previously described including, but not limited to, a Ranked List of requirements, a Budget Scenario Ranked Requirements Report, etc.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A method for generating a capital budgeting plan for real property comprising the steps of:
storing real property information on a computer having a storage, the real property information including data relating to the current status and configuration of the real property;
forming a set of rules providing a relative ranking of project criteria for the real property where the relative ranking is customizable by the user, the project criteria selected from the group consisting of: FCI, one or more project categories, one or more project systems, one or more property uses and combinations thereof;
inputting project information into the computer relating to real property projects for the real property;
the computer ranking the real property projects based on the real property information and the set of rules;
the computer generating a first list of real property projects based on the ranking, said first list of real property projects includes a calculated score which is used to determine a calculated rank for each real property project;
the computer displaying the first list to a user;
inputting override data by the user into the computer relating to at least one real property project on the first list of real property projects, such that the at least one real property project is tagged with the override data;
the computer re-ranking the real property projects based on the real property information and the set of rules and the override data, such that the ranking of the at least one real property project is adjusted relative to the remaining real property projects based on the user inputted override data;
the computer generating a second list of real property projects based on the re-ranking, said second list including the calculated score for each real property project and displayed on said second list with an indication of whether an override is present; and
the computer displaying the second list to the user.

2. The method according to claim 1 wherein when the one or more project categories is selected as part of the project criteria, the one or more project categories is selected from the group consisting of: air quality, water quality, energy, environmental, functionality, code, life safety and combinations thereof.

3. The method according to claim 2 wherein the set of rules is determined by providing a relative ranking for the one or more selected project categories.

4. The method according to claim 1 wherein when the one or more project systems is selected as part of the project criteria, the one or more project systems is selected from the group consisting of: exterior, plumbing, finishes, electrical, interior, roof and combinations thereof.

5. The method according to claim 2 wherein the set of rules is determined by providing a relative ranking for exterior, plumbing, finishes, electrical, interior and roof.

6. The method according to claim 1 wherein the set of rules further comprises one or more property redundancies.

7. The method according to claim 6 wherein the one or more property redundancies is selected from the group consisting of: multiple facility operation, secondary facility available operation, unique facility operation and combinations thereof.

8. The method according to claim 1 wherein the sets of rules further comprise the number of floors for the property.

9. The method according to claim 1 wherein the project information includes data selected from the group consisting of: property identification, project description, project cost, project duration and combination thereof.

10. The method according to claim 9 wherein the step of generating a graph further comprises listing project cost versus FCI.

11. A system for generating a capital budgeting plan for real property comprising:
a computer having software executing thereon for generating a capital budgeting plan;
a storage accessible by said computer;
real property information stored on said storage, said real property information including data relating to the current status and configuration of the real property;
a set of rules stored on said storage, said set of rules providing a relative ranking of project criteria for the real property where the relative ranking is customizable by the user, the project criteria selected from the group consisting of: FCI, one or more project categories, one or more project systems, one or more property uses and combinations thereof;
project information entered into said software program, said project information relating to real property projects for the real property;
said software ranking the real property projects based on said real property information and said set of rules;
a first list of real property projects generated by said software, said list based on the ranking, said first list of real property projects includes a calculated score which is used to determine a calculated rank for each real property project;
a display for displaying the first list to a user;
override data entered into said software program by a user, said override data relating to at least one real property project on the first list of real property projects, such that the at least one real property project is tagged with the override data;
said software re-ranking the real property projects based on said real property information and said set of rules and the override data, such that the ranking of the at least one real property project is adjusted relative to the remaining real property projects based on the user inputted override data;
a second list of real property projects generated by said software, said list based on the re-ranking, said second list including the calculated score for each real property project and displayed on said second list;
said second list presented on said display.

12. The system according to claim 11 wherein when the one or more project categories is selected as part of the project criteria, the one or more project categories is selected from the group consisting of: air quality, water quality, energy, environmental, functionality, code, life safety and combinations thereof.

13. The system according to claim 12 wherein the set of rules is determined by providing a relative ranking for the selected one or more selected project categories.

14. The system according to claim 11 wherein when the one or more project systems is selected as part of the project criteria, the one or more project systems is selected from the group consisting of: exterior, plumbing, finishes, electrical, interior, roof and combinations thereof.

15. The system according to claim 14 wherein the set of rules is determined by providing a relative ranking for exterior, plumbing, finishes, electrical, interior and roof.

16. The system according to claim 11 wherein the set of rules further comprises one or more property redundancies.

17. The system according to claim 16 wherein the one or more property redundancies is selected from the group consisting of: multiple facility operation, secondary facility available operation, unique facility operation and combinations thereof.

18. The system according to claim 11 wherein the set of rules further comprises the number of floors for the property.

19. The system according to claim 11 wherein the project information includes data selected from the group consisting of: property identification, project description, project cost, project duration and combination thereof.

20. The system according to claim 19 wherein the graph further lists project cost versus FCI.

21. The method according to claim 1 wherein said first list of real property projects includes an FCI for each real property project.

22. The method according to claim 1 wherein said first list of real property projects includes a category for each real property project.

23. The method according to claim 1 wherein said first list of real property projects includes fiscal year for each real property project.

24. The method according to claim 23 wherein said first list of real property projects allows for selection of a plurality of fiscal years to be displayed.

25. The method according to claim 1 wherein said first list of real property projects includes an estimated cost for each real property project.

26. The method according to claim 1 wherein said first list of real property projects includes an description and a location of each real property project.

27. The system according to claim 11 wherein said first list of real property projects includes an FCI for each real property project.

28. The system according to claim 11 wherein said first list of real property projects includes a category for each real property project.

29. The system according to claim 11 wherein said first list of real property projects includes fiscal year for each real property project.

30. The system according to claim 29 wherein said first list of real property projects allows for selection of a plurality of fiscal years to be displayed.

31. The system according to claim 11 wherein said first list of real property projects includes an estimated cost for each real property project.

32. The system according to claim 11 wherein said first list of real property projects includes an description and a location of each real property project.
